(19) United States
(12) Patent Application Publication
(10) Pub. No.: US 2026/0202655 A1
(43) Pub. Date: Jul. 16, 2026

(54) METHOD FOR LIGHT MICROSCOPIC IMAGING OF A SAMPLE, DEVICE, AND COMPUTER PROGRAM

(71) Applicant: ABBERIOR INSTRUMENTS GMBH, Gottingen (DE)

(72) Inventors: Andreas SCHONLE, Gottingen (DE); Lars KASTRUP, Gottingen (DE)

(21) Appl. No.: 19/439,700

(22) Filed: Jan. 5, 2026

(30) Foreign Application Priority Data
Jan. 14, 2025 (DE) 10 2025 101 102.8

(51) Int. Cl. G02B 21/00; G01N 21/64; G01Q 60/38

(52) U.S. Cl. CPC G02B 21/0076; G01N 21/6458; G01Q 60/38; G01N 2021/6463; G01N 2201/105

(57) ABSTRACT

A method for light microscopic imaging, wherein an illumination light focus is scanned over or through a sample during a pre-scan of a sample area, light emissions from emitters in the sample are detected and assigned to target positions of the at least one illumination light focus, and actual positions of the illumination light focus corresponding to the target positions are detected during the pre-scan. Within a sub-area of the sample area, a subsequent step is performed in which a position or positions in the sample area imaged by the pre-scan is or are targeted on the basis of the detected actual positions, or image processing is carried out on the basis of the detected light emissions and the assigned actual positions, and/or at least one measured value is determined. Devices and computer programs configured to perform the method are also provided.

### CROSS-REFERENCE TO RELATED APPLICATIONS

The present application claims the benefit of and priority to German Patent Application Serial No. 10 2025 101 102.8, filed Jan. 14, 2025, the entire contents of which is incorporated herein by reference.

### TECHNICAL FIELD

The present disclosure relates to methods for light microscopic imaging of a sample using scanning microscopy, as well as apparatuses (in particular scanning light microscopes) and computer programs for performing the methods.

### PRIOR ART

In scanning light microscopy, e.g., confocal laser scanning microscopy, the focus of an illumination light beam is moved over or through a sample, and emission light emanating from the sample is detected at time intervals that are each assigned to a position of the focus in the sample. Based on stored light emission data, a raster image of the sample can be created by representing the light emissions detected at the focus positions as pixel intensities.

The scanning device that scans the illumination light focus over or through the sample is controlled by a control device, whereby target positions are specified for different points in time at which the focus is to be positioned.

However, many scanning devices do not always manage to reach the target positions perfectly, which can result in significant deviations between the target positions and actual positions of the illumination light focus in the sample. This applies in particular to fast scanning speeds, as well as, for example, at reversal points of the scanning field. Such deviations can result, for example, from inaccuracies in the control system and, in particular in the case of mechanical scanning devices, from the inertia of scanner components.

Certain scanning devices, such as galvanometer scanning devices, usually have internal measuring devices that detect, for example, the current position of galvanometer mirrors, i.e., the actual position of the scanner. Such actual positions are usually used as input variables for a control loop, which adjusts the actual positions as closely as possible to the target positions.

Although such control mechanisms reduce the aforementioned deviation, they cannot correct it completely.

When creating raster images, the prior art for assigning light emissions to image pixels is to use the target position of the scanning device. This results in image artifacts such as distortions, which can be inhomogeneous across the image field and occur in particular under certain scanning conditions (e.g., high scanning speed).

Patent specification U.S. Pat. No. 10,795,140 B2 describes a method in which a pixel size is optimized in a laser scanning process in order to optimally image the sample structure. Both target positions and actual positions of the illumination light focus can be used to determine the optimal pixel size.

German patent DE 10 2022 119 589 B3 describes a localization method with a first and a second localization step (in particular according to the MINFLUX principle), wherein a position correction is performed to correct a systematic deviation of the determined emitter position.

German disclosure document DE 10 2021 107 704 A1 describes a method in which the position of reference markers in a sample is determined according to the MINFLUX principle in order to detect drift.

German disclosure document DE 10 2022 123 632 A1 discloses a localization method for individual emitters in a sample (in particular a MINFLUX method) in which light emitted from the sample is detected by multiple detector elements in order to estimate a background and perform a background correction for the specific position of an emitter.

German patent DE 10 2022 119 332 B3 describes a method in which individual emitters are localized using an illumination sequence (in particular according to a MINFLUX method), whereby the illumination sequence is adjusted or determined depending on whether it has been determined that there is at least one second emitter in a first area from which light emissions are detected, or whereby an estimated position of the at least one second emitter is taken into account when locating the first emitter, or whereby an estimated position of the at least one second emitter is taken into account when localizing the first emitter.

Scanning light microscopy is often used to create overview images in order to subsequently perform further measurement or manipulation steps in specific regions of interest. Image artifacts in the overview images can sometimes result in serious errors when targeting the relevant region of interest. This can lead to a subsequent step being performed at the wrong position. The subsequent step may then have to be repeated and, depending on the type of subsequent step, the manipulation of the sample may be damaging and irreversible.

### OBJECTIVE OF THE DISCLOSURE

Therefore, the objective of the present disclosure is to provide a method, that reduce or eliminate the negative influence of image artifacts from scanning light microscopy on position-dependent subsequent steps or a method to improve image quality, and devices, in particular microscopes, that are designed and configured to perform any of the methods, and computer programs for carrying out any of the methods.

### SOLUTION

This objective is attained by the subject matter of independent claims. Advantageous embodiments are given in the subclaims and are described below.

### DESCRIPTION

A first aspect of the disclosure relates to a method for light microscopic imaging of a sample, wherein at least one illumination light focus is scanned over or through the sample during a pre-scan of a sample area of the sample using a scanning device, wherein light emissions from emitters in the sample are detected by a detector during the pre-scan, wherein the light emissions are assigned to target positions of the at least one illumination light focus in the sample, and wherein, during the pre-scan, an actual position of the at least one illumination light focus in the sample, which is assigned to the target positions, is detected by a measuring device, wherein a subsequent step is performed within a sub-region of the sample region, in which a position in the sample region imaged by the pre-scan is targeted on the basis of the detected actual positions.

By using the actual positions, the subsequent step can be performed with greater accuracy in the desired region of the sample, for example on a sample structure that was imaged by the pre-scan. This is also the case if the image data obtained during the pre-scan contains image artifacts, e.g., image field distortions. Based on a distorted pre-scan, the actual position of certain structures in the sample may only be known very imprecisely. Even if the subsequent step is performed with the same scanning device, the subsequent step typically has a different relationship between target positions and actual positions than in the pre-scan. Since image artifacts are tolerable in the pre-scan, it is also possible to perform the pre-scan with more favorable scan parameters, e.g., a higher scan speed, which saves measurement time.

The term “pre-scan” is intended to express that, after this scan, a further scan of the sample area may be performed, e.g., a “fine scan” in the sub-area of the sample area. Apart from this, the term “pre-scan” is not intended to imply any restrictions. The pre-scan can be performed in a variety of ways (in particular, those known in the prior art).

The measuring device, which detects the actual positions, may in particular comprise a sensor that can measure, for example, a position of the light beam in the beam path of the light microscope or also a position of an optical element of the scanning device. This sensor may be integrated into the scanning device or may be designed separately from the scanning device and arranged outside the latter in the beam path.

The illumination light focus can be, for example, an excitation light focus, whereby the emitters in the sample can reflect or scatter the excitation light, or the emitters can be excited by the excitation light to luminescence, in particular fluorescence. Alternatively, the illumination light focus can also be, for example, a superposition of an excitation light focus and a focus of a prevention light (e.g., STED light, where STED stands for stimulated emission depletion), wherein the prevention light has an intensity distribution with a local minimum, and wherein the superimposed foci are scanned together over or through the sample.

The emitters can be, for example, fluorophores or sample structures labeled with one or more fluorophores.

The light emissions can be, for example, fluorescence photons. Optionally, individual photons can be detected by the detector, as is possible, for example, with avalanche photodiodes (APDs) or two-dimensional arrays of such photodetectors.

Detection can be performed confocally, i.e., the detection light is imaged onto a detector in an image plane of the focal plane in the sample, wherein the detector has one or more detection apertures. A detection aperture can be a pinhole or a delimited light-sensitive area, i.e., a pixel, of a detector with multiple detector elements. One or more pixels of a detector can form a so-called synthetic pinhole aperture if, in a detector with multiple detector elements in a detection plane, a sum signal of the detector elements in a central area, which corresponds to the opening of a pinhole aperture, is evaluated for imaging. In other methods with confocal detection, the signals captured confocally with a pixelated detector are evaluated for imaging using more complex methods, e.g., simultaneous deconvolution.

In this method, a single illumination light focus can be scanned over or through the sample, or, for example, several illumination light foci can be used to illuminate different locations in the sample in parallel.

The scanning device can be, for example, a mechanical scanning device such as a galvanometer scanning device. A galvanometer scanning device has at least one galvanometer scanner, which comprises a mirror that can be rotated around an axis by a galvanometer drive. Particularly in galvanometer scanning devices, significant artifacts such as image distortions occur at high scanning speeds.

According to one embodiment, the subsequent step is an illumination step, wherein the sub-area is illuminated in the illumination step, in particular through the scanning device, with the at least one illumination light focus or another light (in particular a focus of another light), wherein in the illumination step a position of the illumination light focus or the other light is controlled on the basis of the detected actual positions. The phrase “through the scanning device” indicates, that the illumination light passes the scanning device and is directed by the scanning device.

The displacement of the position of the illumination light focus or the other light in the subsequent step or for the subsequent step can be performed in particular with the same scanning device as the pre-scan. Alternatively, the position can also be shifted using a different scanning device than the pre-scan, e.g., using a fast scanning device with a smaller image field, such as an electro-optical deflector or an acousto-optical deflector.

In the illumination step, the sub-area of the sample can be imaged or the sample can be manipulated, for example. Such manipulation can be, for example, activation or deactivation of emitters in the sample, or also a physical interaction such as laser cutting, removal of material using laser light, or also the displacement of an object (e.g., “grasping” and moving an object using laser tweezers).

According to a further embodiment, the controlling of the position of the illumination light focus or the other light is carried out on the basis of an evaluation of light emissions associated with the actual positions detected from the sample during the pre-scan.

This is particularly useful if certain sample structures that were imaged in the pre-scan are to be targeted in the subsequent step. If, for example, a corresponding area of the sample has been selected on the basis of the pre-scan, the actual positions measured by the measuring device can be determined for this area. The illumination step can then be performed at the corresponding positions.

According to a further embodiment, an evaluation or representation of light emissions detected in the illumination step is additionally performed.

The assignment of the light emissions obtained in the pre-scan can be corrected, for example, on the basis of the measured actual positions. In particular, in the case of a sample that emits only weak light, the light emissions from the subsequent step (here, the illumination step) can also be combined with the light emissions from the pre-scan.

According to a further embodiment, the sample is scanned in the illumination step by the scanning device with the illumination light focus or the other light in the sub-area, whereby light emissions from the sample are detected during the scan, in particular whereby a scan image of the sub-area is generated.

The scan image can be used, for example, to examine the sub-area identified by the pre-scan in more detail. In particular, in this case, the sample can be illuminated with additional or different light during the illumination step in order to obtain additional or different information or to achieve a higher resolution. For example, the sample can be examined in the illumination step using STED microscopy, or other emitters in the sample can be excited, e.g., by illumination with light of a different color.

According to a further embodiment, different scanning parameters are used in the illumination step than in the pre-scan, in particular, a scanning speed in the illumination step is lower than in the pre-scan.

According to a further embodiment, a measured variable is determined on the basis of the light emissions detected in the illumination step.

According to a further embodiment, the measured variable is a position of a structure in the sample imaged in the pre-scan, a distance between structures in the sample imaged in the pre-scan, or an area of at least one structure in the sample, or the measured variable describes a shape, a type, and/or a number of structures or objects in the sample.

According to a further embodiment, at least one localization of an individual emitter in the sample is determined in the illumination step.

In this specification, the term “localization” refers to the determination of the position of a single emitter in the sample independently of other surrounding emitters.

An “emitter” is understood to be the unit in the sample that acts as a point light source. This can be, for example, a single fluorophore, a reflective nanoparticle or a nanoparticle marked with fluorophores, or even a sample structure marked with several fluorophores at a small, optically non-resolvable distance.

An “isolated” emitter is a single emitter that can be optically separated from surrounding emitters. Optical separability can be achieved in particular by ensuring that the emitter is at a distance above the diffraction limit of light microscopy from other emitters emitting light at that moment. Inactive emitters, e.g., emitters in a transient dark state, may well have a smaller distance from the emitter to be localized. Under certain circumstances, emitters with a distance below the diffraction limit can also be optically separated, e.g., due to different emission spectra or emission lifetimes.

According to a further embodiment, the localization is determined by arranging an intensity distribution of an illumination light with a local minimum at illumination positions in an area around a presumed position of an isolated emitter, separately detecting light emissions from the sample for the respective illumination positions and estimating the position of the emitter based on the light emissions and the associated illumination positions or by arranging different intensity distributions of an illumination light with a local minimum at at least one illumination position overlapping with a presumed position of an isolated emitter, separately detecting light emissions from the sample for respective shapes and/or arrangements of the intensity distribution and estimating the position of the emitter based on the light emissions and the associated illumination position or associated illumination positions and the respective shapes of the intensity distribution.

Such methods include so-called MINFLUX methods, in which an intensity distribution of excitation light is arranged at different illumination positions around the presumed position, and STED-MINFLUX methods, in which the intensity distribution is a STED light distribution that is superimposed with focused excitation light.

The actual positions and their assignment to the light emissions obtained in the pre-scan can particularly be used for such a localization method based on directed targeting of coordinates, such as MINFLUX, especially since the presumed position can be determined more accurately on the basis of the actual positions, so that the localization method can be carried out more effectively, i.e., with fewer photons per piece of information obtained.

According to a further embodiment, the sample is illuminated with manipulation light in the illumination step, wherein the manipulation light affects emitters in the sample, in particular wherein the manipulation light is activation light or inactivation light.

With this embodiment, it is possible to manipulate emitters more precisely using the actual positions, in particular to activate or deactivate them.

According to a further embodiment, the subsequent step is a sensor measurement step, wherein in the sensor measurement step a sensor is positioned at the targeted position, wherein an actuator coupled to the sensor is controlled on the basis of the detected actual positions.

A sensor measurement step is understood to be a step in which at least one physical measurement variable is detected with a sensor in or on the sample, whereby the measurement is not a light microscopic image.

According to a further embodiment, the sensor device has as a sensor an electrode, in particular a patch-clamp electrode.

The patch-clamp technique can be used, for example, to perform electrical measurements on ion channels in the membranes of biological cells. To do this, the patch-clamp electrode must first be brought into contact with the surface of a cell. This positioning can be carried out with particular accuracy using the actual positions according to the disclosure.

According to a further embodiment, the sensor device has as a sensor a cantilever of an atomic force microscope.

Using Atomic force microscopy (AFM), for example surface profiles of samples can be determined with very high spatial resolution. In this process, a cantilever with a measuring tip is brought into close spatial contact with the surface. With the method according to the disclosure, a sample position to be examined using AFM technology can be targeted particularly precise on the basis of the actual positions of the pre-scan.

According to a further embodiment, the subsequent step is a manipulation step in which a manipulator or actuator that physically interacts with the sample is controlled on the basis of the recorded actual positions.

Such a manipulator can be, for example, a microneedle or a microblade. The microneedle can be used, for example, to remove material from the sample or to inject material into the sample. A microblade can be used, for example, to separate or remove material from the sample.

With the method according to the disclosure, the positioning of the manipulator can be carried out more accurately based on the actual positions of the pre-scan.

According to a further embodiment, an overview image of the sample area is calculated on the basis of the target positions and the light emissions associated with the target positions recorded during the pre-scan and displayed by a display unit. This overview image may have a comparatively low resolution and may also be distorted by image artifacts, as long as sample structures on which a subsequent step is to be performed are recognizable in this image. Even if the sample structures of interest are distorted in the overview image, a suitable location for the subsequent step can still be selected, since the actual coordinates for targeting in the subsequent step are then determined using the actual positions.

According to a further embodiment, the displayed overview image is corrected on the basis of the recorded actual positions. This optional additional correction facilitates the recognition of the sample structures to be selected for the subsequent step, but is not absolutely necessary, since the actual positions are already used for targeting in the subsequent step.

According to a further embodiment, the user selects the sub-area of the sample area in which the subsequent step is to be performed in the overview image.

For example, the user can use a computer mouse or touchpad to draw a box around an area or object in the overview image in which or for which the subsequent step is to be performed.

According to a further embodiment, the subsequent step is performed automatically. In particular, the subsequent step is performed automatically with the aid of a trained data processing network, whereby the actual positions are used as input values for the data processing network.

Such a data processing network can be trained in particular to recognize certain objects or sample structures in the overview image, for which the subsequent step is then performed automatically.

The overview image is therefore also used in particular as input for the data processing network. The data processing network can be, for example, an artificial neural network or similar.

A second aspect of the disclosure relates to a method for light microscopic imaging of a sample, wherein at least one illumination light focus is scanned over or through the sample during a pre-scan of a sample area of the sample using a scanning device, wherein light emissions from emitters in the sample are detected during the pre-scan using a detector, wherein the light emissions are assigned to target positions of the at least one illumination light focus in the sample, and wherein, during the pre-scan, an actual position of the at least one illumination light focus in the sample assigned to the target positions is detected by a measuring device, whereby light emissions detected from the sample during the pre-scan are assigned to respective actual positions, whereby on the basis of the light emissions and the assigned actual positions image processing is performed and/or at least one measured value is determined.

In contrast to the alternative solution according to the first aspect, in this case no subsequent step needs to be performed, but rather the light emissions detected during the pre-scan and the associated detected actual positions are analyzed in order to determine a measured value, or image processing of the image data from the pre-scan is performed with the aid of the actual positions.

The term “image processing” describes a process in which the pixel values of an image (i.e., for the pre-scan, the light emissions assigned to a specific image element) are converted into processed pixel values for at least some of the pixels. Image processing according to the specific definition used here does not involve a pure regrouping of the light emission to other pixels. For example, this does not include adjusting the pixel size to an optimal value.

This alternative is particularly useful in that image processing is improved due to the knowledge of the actual arrangement of the sample structures derived from the actual positions.

According to a further embodiment, arrival times of individual photons emitted from the sample are recorded, whereby the individual photons are assigned to a respective actual position based on their respective arrival time, whereby the image processing and/or the determination of the at least one measured value is performed based on the individual photons.

Single photon avalanche photodiodes (SPADs) or two-dimensional arrays of such photodiodes are suitable for detecting individual photons and determining the arrival times, wherein the corresponding detector is coupled to evaluation electronics (e.g., based on TCSPC technology, TCSPC stands for eng. time correlated single photon counting).

Since the actual positions for different points in time are known, the arrival times can be used to assign individual detected photons to their respective actual positions with a high degree of accuracy. This can be used, for example, to obtain a scan image with a virtually infinite resolution.

Of course, fluorescence lifetime imaging (FLIM) or similar analyses can also be performed based on the arrival times.

According to a further embodiment, an image of the sample area created by image processing is displayed by a display unit.

According to a further embodiment, the image processing is a deconvolution, in particular an iterative deconvolution.

In the context of the present specification, “deconvolution” is understood to mean a reconstruction method of an object function from image data, whereby the image data can be mathematically described as a convolution of the object function with a point spread function of an optical system imaging the sample. The point spread function of the imaging optical system may be location-dependent, in which case the image data results in a more complex manner from the object function and the location-dependent imaging properties. Such reconstruction methods are not exact in the presence of noise, i.e., they only reconstruct the object function approximately.

In particular, deconvolution is performed on the basis of individual detected photons, each of which is assigned an actual position. The assignment of the photons to the actual positions can be performed as described above on the basis of the measured arrival times of the photons.

In particular, the detected photons do not enter the target variable to be optimized during deconvolution (also referred to as the “figure of merit”) as usual as an “image” or “image volume” with uniform pixels or voxels. Instead of creating such an image from the target or known actual positions and deconvolving it, an alternative is to group the photons into spatial clusters, in particular of different sizes, so that certain numbers of detected photons are achieved, or to calculate the probabilities of the respective time intervals between detected photons.

For example, in an iterative deconvolution process (in particular based on a detected photon stream), the deviation between a distribution of time intervals between successive detected photons expected for a specific object function and a measured distribution of time intervals can be minimized, thereby obtaining an estimate of the object function.

According to a further embodiment, the measured value is a position of a structure imaged in the sample during the pre-scan, a distance between structures imaged in the sample during the pre-scan, or an area of at least one structure in the sample, or the measured value describes a shape, type, and/or number of structures or objects in the sample.

Such measurements may relate, for example, to distances between biological cells or organelles or the size of certain structures, from which statements about the biological state of the cells or cell groups can be derived.

According to the disclosure, such measured variables can be determined more accurately, since possible image distortions of the pre-scan can be corrected during evaluation.

According to a further embodiment, the measured value is determined by use of a trained data processing network, in particular by use of a data processing network trained for object recognition. The data processing network can be, for example, an artificial neural network.

According to a further embodiment, several illumination light foci are scanned over or through the sample during the pre-scan.

A third aspect of the disclosure relates to an apparatus, in particular a light microscope, for light microscopic imaging of a sample, comprising a scanning device (e.g., a galvanometer scanning device) designed to scan an illumination light focus (in particular an excitation light focus) over or through a sample, a detector (e.g., a SPAD or a SPAD array) designed to detect light emissions (in particular luminescence, more specifically fluorescence) from emitters (in particular fluorophores) in the sample, and a measuring device designed to detect actual positions of the at least one illumination light focus in the sample, wherein the device comprises a control unit designed to control the scanning device and the detector in such a way that a method according to the first aspect is performed.

A fourth aspect of the disclosure relates to an apparatus, in particular a light microscope, for light microscopic imaging of a sample, comprising a scanning device (e.g., a galvanometer scanning device) which is designed to scan an illumination light focus (in particular an excitation light focus) over or through a sample, a detector (e.g., an SPAD or an SPAD array) which is designed to detect light emissions (in particular luminescence, more particularly fluorescence) from emitters (in particular fluorophores) in the sample, and a measuring device which is designed to detect actual positions of the at least one illumination light focus in the sample during the pre-scan, wherein the device comprises a control unit and/or a computing unit which is designed to carry out the method according to the second aspect.

A fifth aspect of the disclosure relates to a computer program comprising instructions that, when executed by one or more processors associated with the apparatus for light microscopic imaging of a sample according to the third aspect, cause the apparatus to perform the method according to the first aspect.

A sixth aspect of the disclosure relates to a computer program comprising instructions that, when executed by one or more processors associated with an apparatus for light microscopic imaging of a sample according to the fourth aspect, cause the apparatus to perform the method according to the second aspect.

Further features and advantages of the devices according to the third and fourth aspects and the computer programs according to the fifth and sixth aspects are apparent from the description of the first and second aspects, respectively.

Further embodiments or details of embodiments are apparent from the patent claims, the description and the drawings and the associated explanations of the drawings. The advantages described in the description of features and/or combinations of features of the disclosure are merely exemplary and may be alternative or cumulative in effect.

The following describes embodiments of the disclosure with reference to figures. These do not limit the subject matter of this disclosure and the scope of protection.

### BRIEF DESCRIPTION OF THE FIGURES

FIG. 1 shows a schematic representation of an embodiment of the method according to the disclosure;

FIG. 2 shows a first embodiment of the apparatus according to the disclosure;

FIG. 3 shows a second embodiment of the apparatus according to the disclosure with a sensor device;

FIG. 4 shows a third embodiment of the apparatus according to the disclosure with a manipulator;

FIG. 5 shows a fifth embodiment of the apparatus according to the disclosure with a computing unit.

### DESCRIPTION OF THE FIGURES

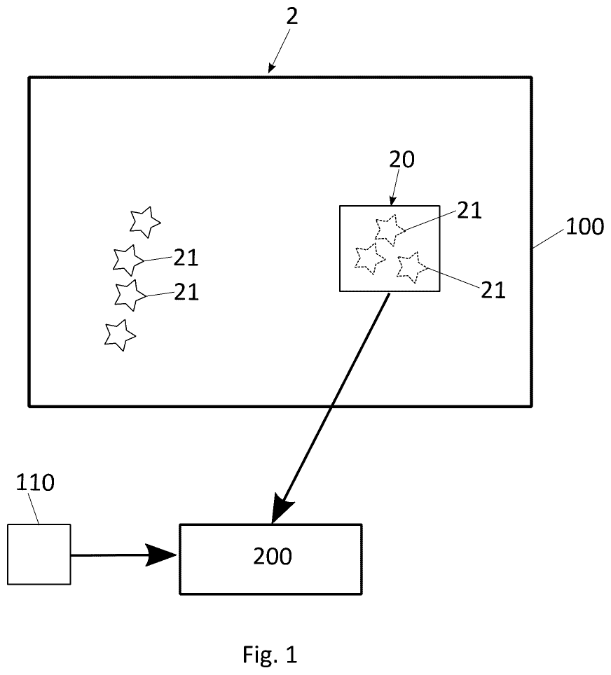

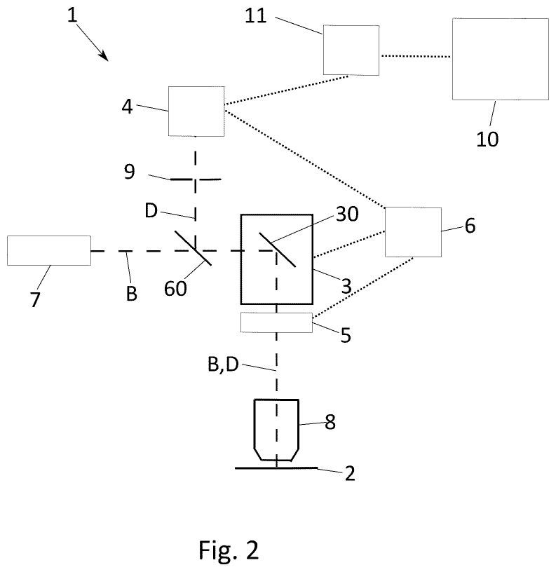

FIG. 1 schematically shows an area of a sample 2 with several structures 21 imaged by light microscopy using a pre-scan 100. In the pre-scan 100, an illumination light focus is scanned over or through the sample 2. At the same time, a measuring device 5 (see in FIGS. 2 to 5) records actual positions 110 of the illumination light focus. The structures 21 can be, for example, biological cells or organelles or other structures within a biological cell. The area of sample 2 shown can be displayed, for example, as a scan image on a display unit 10 (see in FIGS. 2 to 5) of a light microscope. Such a scan image can be calculated on the basis of target positions of the illumination light focus and light emissions from the sample 2 assigned to the target positions. Through user interaction or automatic image evaluation based on the scan image, a sub-area 20 of the sample 2 can be selected in which structures 21 of interest are located.

According to an embodiment of the method according to the disclosure, a subsequent step 200 can then be performed for the sub-area 20 or in the sub-area 20. This subsequent step 200 is performed on the basis of the actual positions 110 detected by the measuring device 5. According to an implementation example, the subsequent step 200 may be, for example, a fine scan of the sub-area 20 with the illumination light focus using scan parameters that have been adjusted in comparison to the pre-scan, e.g., a lower scan speed. Alternatively, in the subsequent step 200, e.g., a localization of individual emitters arranged in the sub-area 20 can be performed.

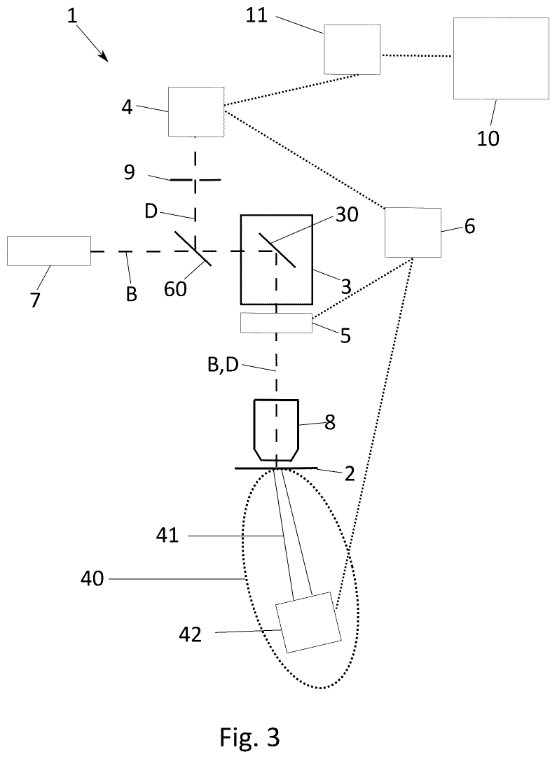

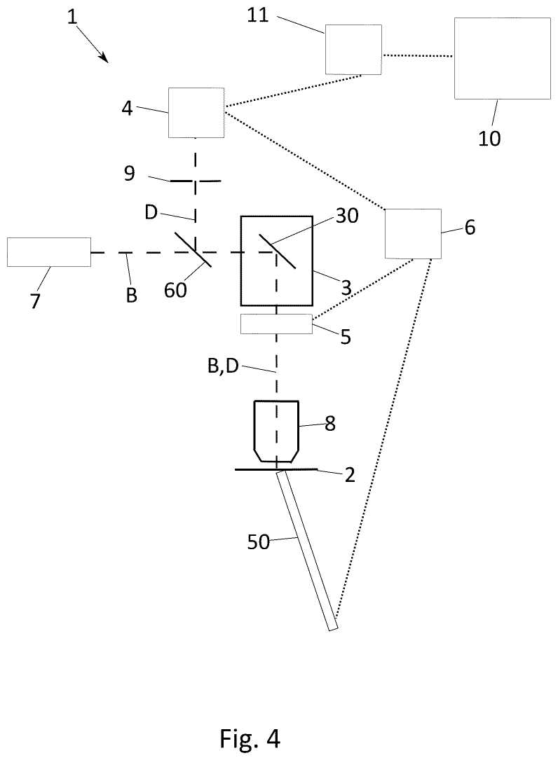

In the subsequent step, an actuator 42 (see in FIG. 3) of a sensor device 40 (see in FIG. 3), which may comprise a sensor such as a patch-clamp electrode or a cantilever of an AFM device or a manipulator 50 (see in FIG. 4) such as a needle or a blade can also be controlled on the basis of the actual positions 110 in order to position the sensor of the sensor device 40 or the manipulator 50 at a specific location in the sub-area of the sample 2.

As an alternative to the subsequent step 200, a measured value can also be determined on the basis of the actual positions 110, or image processing, e.g., deconvolution, can be performed.

FIG. 2 schematically shows an example of apparatus 1 for carrying out the method according to the disclosure, in this case a light microscope for examining the sample 2. The apparatus 1 comprises a light source 7 (e.g., a laser) for generating an illumination light B, a beam splitter 60 (e.g., a dichroic mirror) for separating the illumination light B from detection light D, a scanning device 3 (e.g., a galvanometer scanning device) with a movable optical element 30 (e.g., a galvanometer mirror) for scanning an illumination light focus of the illumination light B over or through the sample 2, and an objective lens 8 for focusing the illumination light B into the sample 2 (generation of the illumination light focus). Detection light D, e.g., fluorescence light, emanating from the sample 2 is formed into a bundle by the objective lens 8, de-scanned by the scanning device 3, and directed by the beam splitter 60 through a pinhole aperture 9 onto a detector 4 (e.g., an avalanche photodiode). The detector 4 detects the detection light D and generates a corresponding detection signal.

A display unit 10 is connected to a computing unit 11, which is connected to the detector 4. The display unit 10 can be used to display a scan image determined by the computing unit 10 on the basis of the light emissions detected by the detector 4, i.e., the detected detection light D, and on the basis of target positions and/or the actual positions 110 of the illumination light focus.

Furthermore, the measuring device 5 is provided for determining the actual positions 110 of the illumination light focus in the sample 2. The measuring device 5 may comprise, for example, a sensor arranged in the beam path of the apparatus 1, which determines a position of an illumination light beam of the illumination light B in the beam path. Alternatively, the measuring device 5 can, for example, also measure the position of the movable optical element 30 of the scanning device 3, whereby the actual positions 110 of the illumination light focus can be determined indirectly. In the latter case in particular, the measuring device 5 can, for example, also be integrated into the scanning device 3.

Furthermore, a control unit 6 coupled to the detector 4 and the measuring device 5 is provided, which controls the subsequent step 20 on the basis of the light emissions from the sample 2 detected by the detector 4 and on the basis of the actual positions 110 of the illumination light focus detected by the measuring device 5.

In the embodiment shown in FIG. 2, the control unit 6 is connected to the scanning device 3 and controls it in order to scan the illumination light focus in the subsequent step 20, in particular with changed scanning parameters, over or through the sample 2.

FIG. 3 shows an alternative embodiment of the apparatus 1 according to the disclosure, in which the control unit 6 controls the actuator 42 of the sensor device 40 on the basis of the actual positions 110 determined by the measuring device 5 and the light emissions detected by the detector 4. The sensor device 40 may comprise, for example, an electrode 41 and the actuator 42 for positioning the electrode 41 relative to the sample 2, wherein the control unit 6 controls the actuator 42. The sensor device 40 may also comprise the actuator 42 for positioning and, as an alternative to the electrode 41, for example, a cantilever (not shown), e.g., for an AFM measurement on the sample 2. The remaining components of the apparatus 1 are identical to those of the embodiment according to FIG. 2 and are provided with the same reference numerals.

FIG. 4 shows a further embodiment of the apparatus 1 according to the disclosure, in which the control unit 6 controls a manipulator 50 on the basis of the actual positions 110 determined by the measuring device 5 and the light emissions detected by the detector 4, which physically manipulates the sample 2, e.g. by deforming, cutting, removing and/or adding material. The remaining components of the apparatus 1 are identical to those of the embodiments according to FIG. 2 and FIG. 3 and are provided with the same reference symbols.

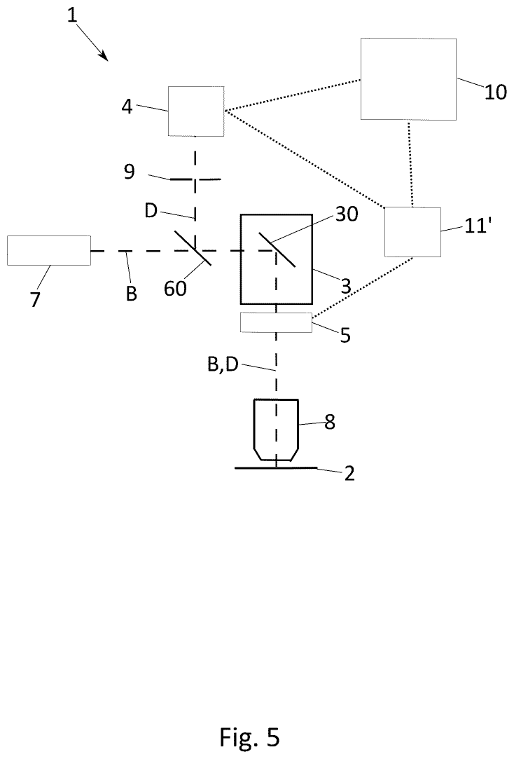

FIG. 5 shows a further embodiment of the apparatus 1 according to the disclosure with a computing unit 11′ that is coupled to the detector 4 and the measuring device 5, wherein the computing unit 11′ is designed to perform image processing of an image using the actual positions 110 of the illumination light focus, wherein the image is generated by scanning the illumination light focus over or through the sample 2 with the scanning device 3 and detecting light emissions from the sample 2 with the detector 4. The processed image obtained by the image processing can be displayed with the display unit 10. The image processing may be, for example, a deconvolution. The detector 4 may be coupled to evaluation electronics to determine arrival times of individual photons emitted from the sample. These individual photons can be assigned to the actual positions 110 of the illumination light focus based on their arrival times. Based on the individual photons, image deconvolution can then be performed, for example. The remaining components of the apparatus 1 are identical to those of the embodiments according to FIG. 2, FIG. 3, and FIG. 4 and are provided with the same reference symbols.

### LIST OF REFERENCE SIGNS

1 Apparatus
2 Sample
3 Scanning device
4 Detector
5 Measuring device
6 Control unit
7 Light source
8 Objective lens
9 Pinhole
10 Display unit
11, 11′ Computing unit
20 Sub-area
21 Structure
30 Movable optical element
40 Sensor device
41 Electrode
42 Actuator
50 Manipulator
60 Beam splitter
100 Pre-scan
110 Actual positions
200 Subsequent step
B Illumination light
D Detection light

1. Method for light microscopic imaging of a sample, wherein during a pre-scan of a sample area of the sample, at least one illumination light focus is scanned over or through the sample using a scanning device, wherein during the pre-scan, light emissions from emitters in the sample are detected using a detector, wherein the light emissions are assigned to target positions of the at least one illumination light focus in the sample, and wherein, during the pre-scan, actual positions of the at least one illumination light focus in the sample assigned to the target positions are detected by a measuring device, wherein a subsequent step is performed within a sub-area of the sample area, in which a position in the sample area imaged by the pre-scan is targeted on the basis of the detected actual positions.

2. The method according to claim 1, wherein the subsequent step is an illumination step, wherein in the illumination step the sub-area is illuminated through the scanning device, with at least one illumination light focus or another light, wherein in the illumination step, a position of the illumination light focus or of the other light is controlled on the basis of the detected actual positions.

3. The method according to claim 2, wherein the controlling of the position of the illumination light focus or of the focus of the other light is carried out on the basis of an evaluation of light emissions associated with the actual positions detected from the sample during the pre-scan.

4. The method according to claim 2, wherein the sample is scanned in the illumination step by the scanning device with the illumination light focus or the focus of the other light in the sub-area, wherein light emissions from the sample are detected during the scan, wherein a scan image of the sub-area is generated.

5. The method according to claim 4, wherein in the illumination step different scan parameters are used than in the pre-scan.

6. The method according to claim 2, wherein at least one localization of an individual emitter in the sample (2) is determined in the illumination step.

7. The method according claim 2, wherein the sample is illuminated with manipulation light in the illumination step, wherein the manipulation light affects emitters in the sample.

8. The method according claim 7, wherein the manipulation light is activation light or inactivation light.

9. The method according to claim 1, wherein the subsequent step is a sensor measurement step, wherein in the sensor measurement step a sensor is positioned at the targeted position, wherein a manipulator or actuator coupled to the sensor device is controlled on the basis of the detected actual positions.

10. The method according to claim 9, wherein the sensor is an electrode or a patch clamp electrode or a cantilever of an atomic force microscope.

11. The method according to claim 1, wherein the subsequent step is a manipulation step in which a manipulator physically interacting with the sample is controlled on the basis of the detected actual positions.

12. The method according to claim 1, wherein, based on the target positions and the light emissions associated with the target positions detected during the pre-scan, an overview image of the sample area is calculated and displayed by a display unit.

13. The method according to claim 12, wherein the sub-area of the sample area in which the subsequent step is performed is selected in the overview image by a user input.

14. Method for light microscopic imaging of a sample, wherein during a pre-scan of a sample area of the sample, at least one illumination light focus is scanned over or through the sample using a scanning device, wherein during the pre-scan, light emissions from emitters in the sample are detected by a detector, wherein the light emissions are assigned to target positions of the at least one illumination light focus in the sample, and wherein, during the pre-scan, actual positions of the at least one illumination light focus in the sample assigned to the target positions are detected by a measuring device, wherein during the pre-scan, light emissions detected from the sample are assigned to respective actual positions, wherein image processing is performed on the basis of the light emissions and the assigned actual positions and/or at least one measured variable is determined.

15. The method according to claim 14, wherein arrival times of individual photons emitted from the sample are detected, wherein the individual photons are assigned to a respective actual position based on their respective arrival time, wherein the image processing and/or the determination of the at least one measured variable is performed based on the individual photons.

16. The method according to claim 14, wherein an image of the sample area created by the image processing is displayed by a display unit.

17. The Method according to claim 14, wherein the measured variable is a position of a structure imaged in the sample during the pre-scan, a distance between structures imaged in the pre-scan in the sample or an area of at least one structure in the sample, or the measured variable describes a shape, a type, and/or a number of structures or objects in the sample.

18. Apparatus for light microscopic imaging of a sample by a method according to claim 1, comprising
a scanning device designed to scan an illumination light focus over or through a sample,
a detector designed to detect light emissions from emitters in the sample,
a measuring device designed to detect actual positions of the at least one illumination light focus in the sample,
a control unit which is designed to control the scanning device.

19. Apparatus for light microscopic imaging of a sample by a method according to claim 14, comprising
a scanning device designed to scan an illumination light focus over or through a sample,
a detector designed to detect light emissions from emitters in the sample,
a measuring device designed to detect actual positions of the at least one illumination light focus in the sample during the pre-scan, and
a computing unit configured to perform image processing on the basis of the light emissions and the actual positions and/or to determine at least one measured variable.

20. Computer program comprising instructions which, when executed by one or more processors associated with an apparatus for light microscopic imaging of a sample, comprising
a scanning device designed to scan an illumination light focus over or through a sample,
a detector designed to detect light emissions from emitters in the sample,
a measuring device designed to detect actual positions of the at least one illumination light focus in the sample,
a control unit which is designed to control the scanning device
causes the apparatus to perform the method according to claim 1.

21. Computer program comprising instructions which, when executed by one or more processors associated with an apparatus for light microscopic imaging of a sample, comprising
a scanning device designed to scan an illumination light focus over or through a sample,
a detector designed to detect light emissions from emitters in the sample,
a measuring device designed to detect actual positions of the at least one illumination light focus in the sample during the pre-scan, and
a computing unit configured to perform image processing on the basis of the light emissions and the actual positions and/or to determine at least one measured variable
causes the apparatus to perform the method according to claim 14.
